(19) United States
(12) Patent Application Publication
(10) Pub. No.: US 2024/0276931 A1
(43) Pub. Date: Aug. 22, 2024

(54) MODULAR PLANT GROWING SYSTEM

(71) Applicant: Air Garden Smarts PTY Ltd., New Farm, Queensland (AU)

(72) Inventors: Amelia Prue Bauer, New Farm, Queensland (AU); William Thomas Bauer, Yeronga (AU)

(73) Assignee: Air Garden Smarts PTY Ltd., New Farm, Queensland (AU)

(21) Appl. No.: 18/571,484

(22) PCT Filed: Jun. 15, 2022
(86) PCT No.: PCT/AU2022/050585

§ 371 Date: Dec. 18, 2023

(30) Foreign Application Priority Data
Jun. 17, 2021 (AU) 2021204042
Jun. 15, 2022 (WO) PCT/AU2022/050585

(51) Int. Cl. A01G 31/06; A01G 27/00; A01G 31/00

(52) U.S. Cl. CPC A01G 31/06; A01G 27/005; A01G 2031/006

(57) ABSTRACT

The present invention relates to a modular plant growing system. The system includes growing modules for growing plants. Each growing module includes fastening means to facilitate releasable fastening with an adjacent growing module. Advantageously, the fastened modules can be fastened together, and later released for cleaning and maintenance using the fastening means, without the need for tools.

### CROSS REFERENCE TO RELATED APPLICATION

This patent application claims the benefit and priority from International Patent Application No. PCT/AU2022/050585, filed on Jun. 15, 2022, and from Australian Patent Application No. 2021204042 filed on Jun. 17, 2021, which International Patent Application No. PCT/AU2022/050585 claims priority to; the disclosure of each is incorporated by reference herein in its entirety as part of the present application.

### TECHNICAL FIELD

The present invention relates to a modular plant growing system. The present invention has exclusive application to hydroponic and aeroponic vertical growing systems.

### BACKGROUND

The reference to any prior art in this specification is not, and should not be taken as an acknowledgement or any form of suggestion that the prior art forms part of the common general knowledge.

Urban gardening has become more popular in recent times, whereby plants are grown in urban areas, such as schools, backyards or apartment balconies.

Modular plant growing systems are known whereby growing modules are fastened together to form a tower using internal rods and screws. However, the Applicant has perceived the need for improved assembly and disassembly, without the need for specialized tools.

Some known growing systems such as U.S. Pat. No. 10,206,344, US 2018/0263201 and PCT/SG2016/050483 have individual water tanks for respective towers which creates problems for monitoring nutrient and PH levels of the water supply, cleaning and maintenance, and increasing cost layout for the user in deployment. Embodiments of the present invention ameliorate these problems or at least provide the user with a useful commercial choice.

### SUMMARY OF THE INVENTION

According to one aspect of the present invention, there is provided a modular plant growing system for hydroponic and/or aeroponic growing plants, the system including:
growing modules for hydroponically and/or aeroponically growing of plants, each growing module including a base and a top for topping a periphery of the base, each growing module including twist lock formations to facilitate twist-locking of the modules together,
wherein the twist lock formations include a bayonet fitting.

Advantageously, each base and top of the modules can be releasably fastened together.

The twist lock formations may lock the base and the top of each module together, as well as adjacent modules together.

Each growing module may include one or more growing ports in which the plants are located. Each module may include five growing ports. Each port may include a pot. Each top may include one or more recesses for receiving the pots. Each base may define recesses to accommodate the plants from a lower module.

The tops may be stacked together. The bases may be stacked together.

The growing modules may fasten together to form a stacked or vertical tower. The tower may include up to ten to fifteen growing modules. The system may include (up to ten to one thousand) towers watered from a central water supply which advantageously enables water quality for each tower to be carefully monitored, facilitates cleaning and maintenance, and/or reduces buying costs for the user.

The system may include an irrigator for irrigating the plants. The irrigator may include a water tank for receiving water draining from the module. The tank may include a lid. The lid may be latched. The lid may be annular. The lid may include a supply inlet for receiving water. The irrigator may include a pump for pumping water to water plants in the modules. The pump may be submersible and located within a tank. The irrigator may include a conduit for conveying water from the pump to the topmost growing module. The irrigator may include a spreader for spreading water irrigating the plants. The tank may include a drain for draining water from the tank. The drain may include a drainage hole, and a bung for plugging the hole.

The system may include a drainage conduit for draining water from the modules.

Each of the parts may be integrally formed, preferably by injection molding.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1a is a side view of a modular plant growing system with a pipe fastening means in accordance with a commercial embodiment of the present invention;

FIG. 1b is a side sectional view showing two installed modular plant growing systems of FIG. 1a;

FIG. 2a is a side view of two fastened growing modules of the system of FIG. 1a;

FIG. 2b is a side sectional view of the growing modules of FIG. 2a;

FIG. 2c is an exploded perspective view of the growing modules of FIG. 2a;

FIG. 3a is a side view of a modular plant growing system with a pipe fastening means in accordance with a residential embodiment of the present invention;

FIG. 3b is a side sectional view of the residential modular plant growing systems of FIG. 3a;

FIG. 4a is a side view of a modular plant growing system with a bayonet fastening means in accordance with a commercial embodiment of the present invention;

FIG. 4b is a side sectional view showing two installed modular plant growing systems of FIG. 4a;

FIG. 5a is a side view of two fastened growing modules of the system of FIG. 4a;

FIG. 5b is a side sectional view of the growing modules of FIG. 5a;

FIG. 5c is an exploded side sectional view of the growing modules of FIG. 5a;

FIG. 6a is a side view of a modular plant growing system with a bayonet fastening means in accordance with a residential embodiment of the present invention;

FIG. 6b is a side sectional view of the residential modular plant growing systems of FIG. 6a;

FIG. 7 is a side sectional exploded view of two growing modules in accordance with another embodiment; and

FIG. 8 is a side sectional view of a modular plant growing system in accordance with another embodiment.

### DETAILED DESCRIPTION OF PREFERRED EMBODIMENTS

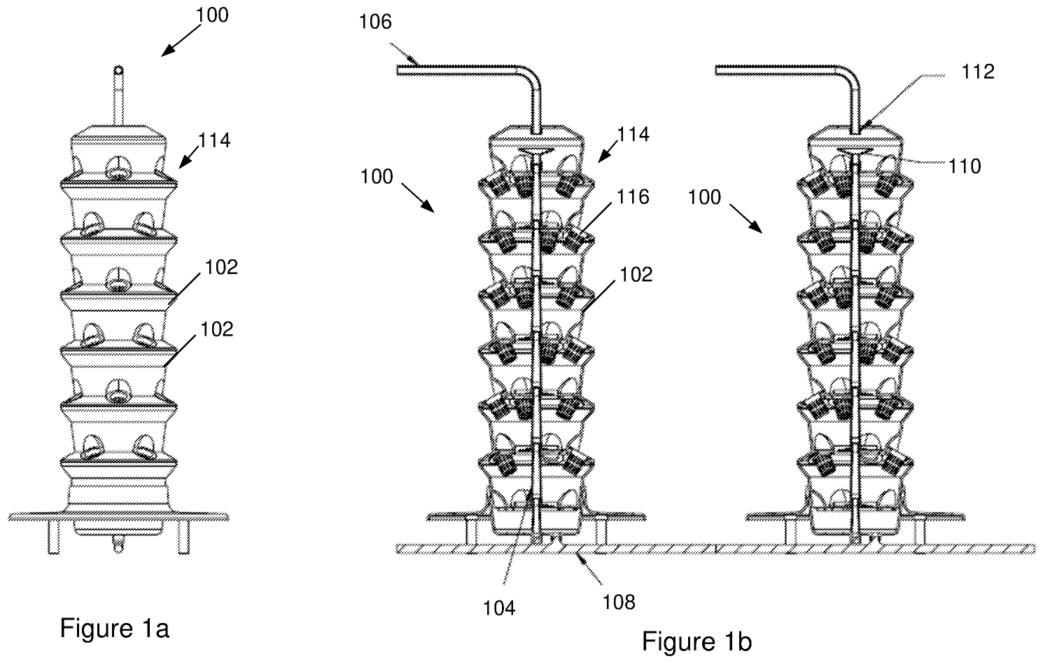

According to an embodiment of the present invention, there is provided a commercial modular plant growing system 100 as shown in FIG. 1. The system 100 includes stacked growing modules 102 for growing plants. Each growing module 102 includes central pipe fastening means 104, as described below, to facilitate releasable fastening with an adjacent growing module 102.

Advantageously, the fastened modules 102 can be rapidly fastened together, and later released for cleaning and maintenance using the pipe fastening means 104, without the need for tools, skill or strength.

As can best be seen in FIG. 1b, the growing modules 102 fasten together to form stacked or vertical towers. Each tower can include up to ten to fifteen growing modules 102. The commercial system 100 can include up to ten to one thousand towers watered through top inlets 106 from a central water supply which advantageously enables water quality (e.g. nutrients, pH, etc.) for the towers to be carefully monitored, facilitates cleaning and maintenance, and reduces buying costs for the user.

The system 100 also includes a common drainage conduit 108 for draining water from the modules 102, at a single point, back to the central water supply. The water supplied from the top inlets 106 is provided to a spreader 110 or shower screen for spreading water to irrigate the plants in the lower modules 102. The spreader 110 can be reversed to form a bung to seal the topmost module 102 at point 112 when not in use.

Each growing module 102 includes five growing ports 114 in which the plants are located. Each port 114 includes a pot 116.

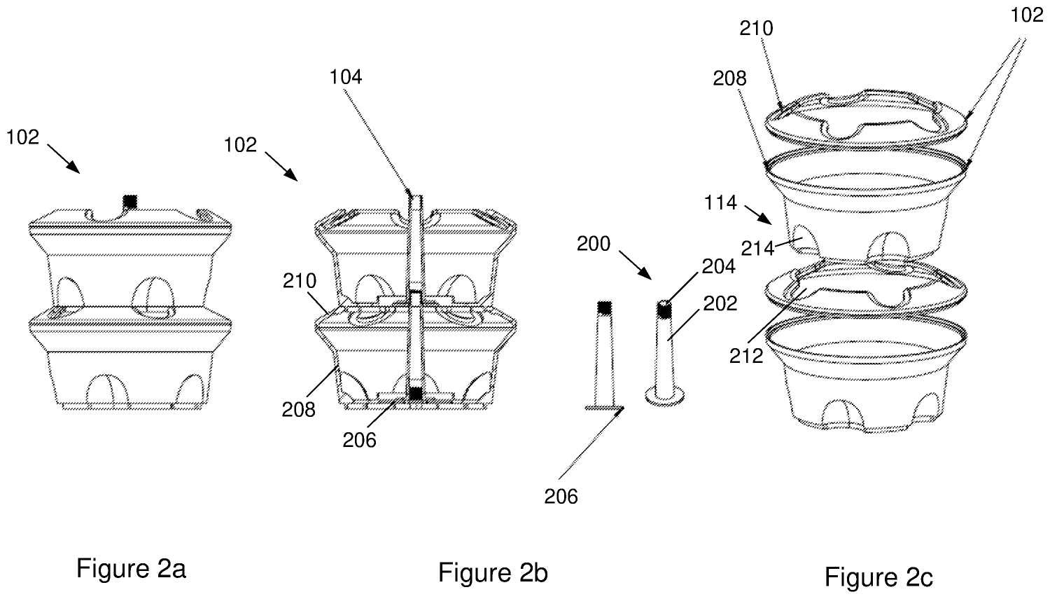

As can best be seen in FIG. 2b, the pipe fastening means 104 includes threadably interconnecting pipes 200. Each pipe 200 has a tapered stem 202 with a threaded free end 204 for hand screwing into an adjacent stem 202. At the base, each pipe 200 includes an annular flange 206 terminating the pipe 200.

As can best be seen in FIG. 2c, each growing module 102 includes a base 208, and a top 210 for topping the base 208. The module base 208 sits on the flange 206 of the centrally located pipe 200, and the top 210 is held in place by the base 208 above. Each top 210 includes recesses 212 for receiving the pots 116 of the ports 114 (see also FIG. 1b). Similarly, each base 208 defines respective aligned recesses 214 to accommodate the plants from a lower module 102.

For transport, prior to assembly, the tops 210 can be stacked and nested together and the bases 208 can be stacked and nested together.

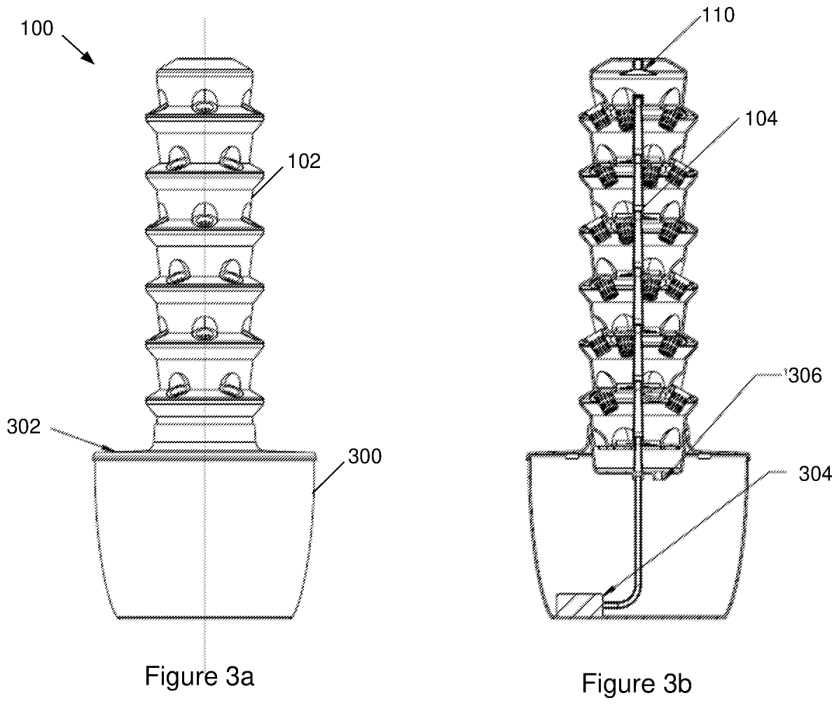

FIG. 3 shows the modular plant growing system 100, with central pipe fastening means 104, adapted for residential use and being portable.

The residential system 100 includes a self-contained irrigator for irrigating the plants. The irrigator includes a water tank 300 for receiving water draining from the modules 102. The 75-litre tank 300 includes an annular, free-turning lid 302 with a supply inlet for receiving fresh water. The irrigator also includes a submersible pump 304, located within the tank 300, for pumping water up through the pipe fastening means 104 to water plants in the modules 102. The pipe fastening means 104 forms a conduit for conveying water from the pump 304 to the spreader 110 in the topmost growing module 102. The irrigator also includes a drain 306 in the lowermost module 102 for draining the water back into the tank 300.

The pipe 200, base 208, top 210, tank 300, and lid 302 are all integrally formed, preferably by injection molding.

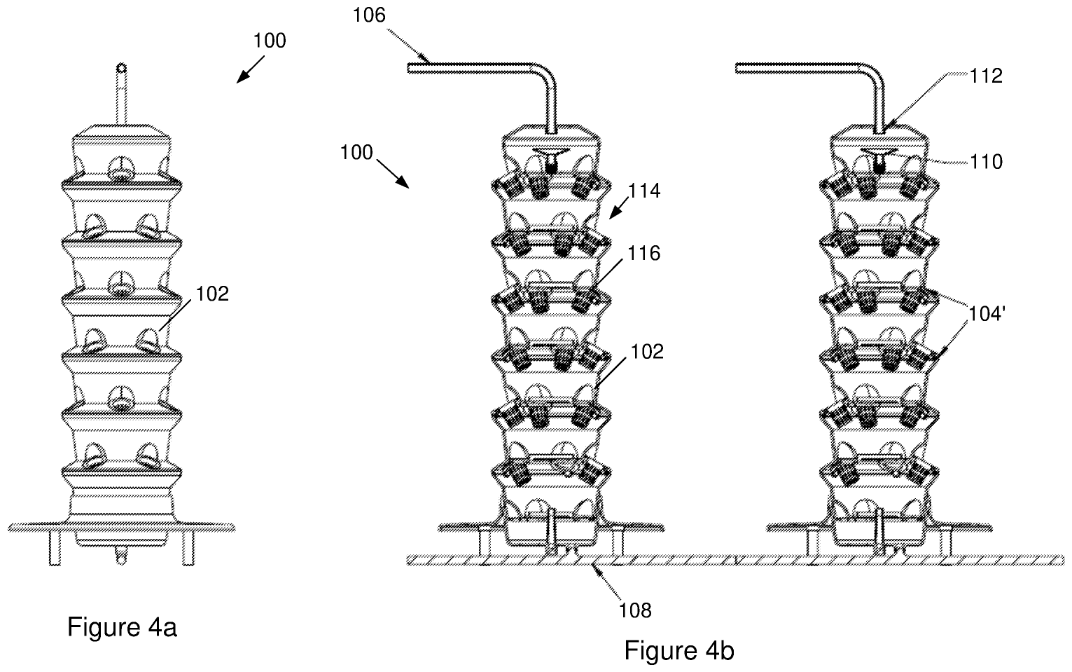

FIG. 4 shows the modular plant growing system 100, with bayonet fastening means 104′, adapted for commercial use.

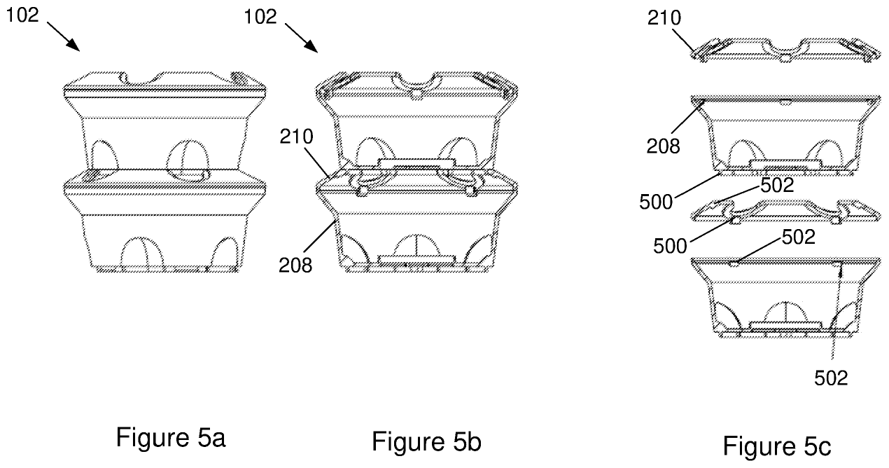

As can best be seen in FIG. 5, the bayonet fastening means 104′ includes twist lock formations to facilitate twist-locking of the modules 102 together. The twist lock formations include a bayonet fitting, with posts 500 for being received in L-shaped slots 502. The twist lock formations therefore lock a base 208 and a top 210 of each module 102 together, as well as adjacent modules 102 together.

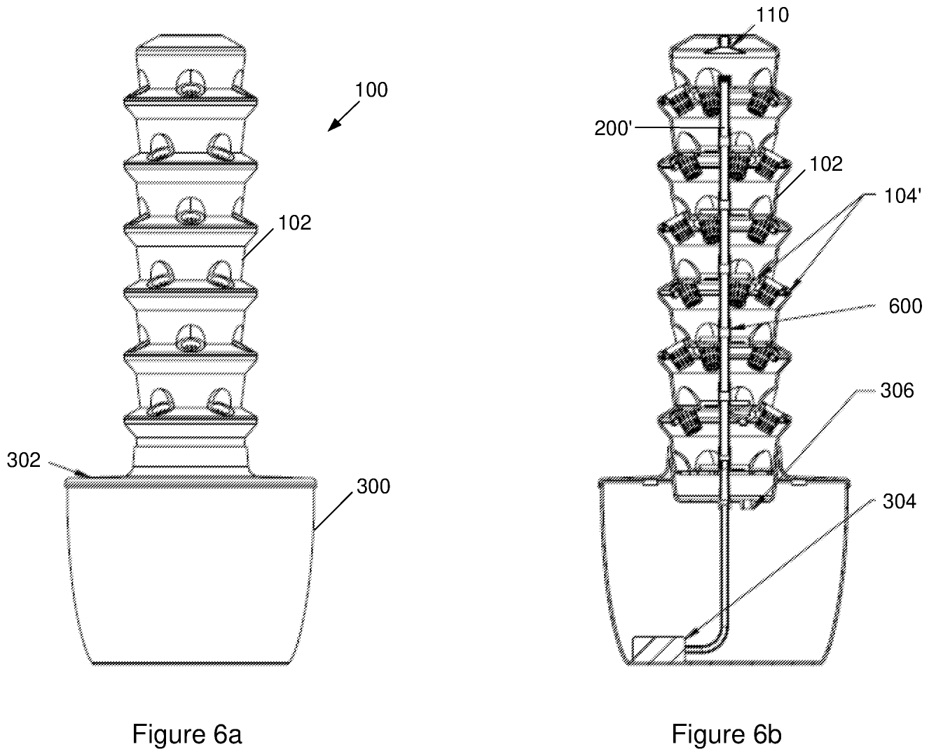

FIG. 6 shows the modular plant growing system 100, with bayonet fastening means 104′, adapted for residential use.

The residential system 100 includes a self-contained irrigator for irrigating the plants. Once again, the system includes a submersible pump 304, located within the tank 300, for pumping water up through a central conduit 600 for conveying water from the pump 304 to the spreader 110 in the topmost growing module 102. However, the conduit 600 is formed from press-fit (and not threaded) pipes 200′ of each module 102.

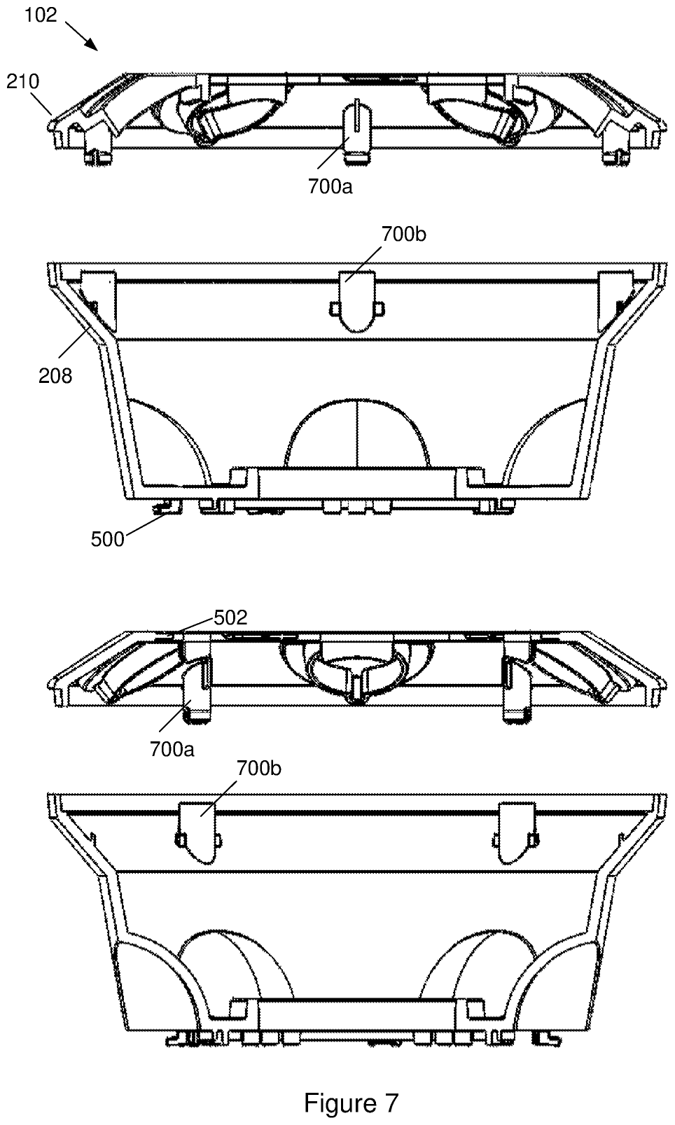

Turing to FIG. 7, each growing module 102 includes a base 208, and a top 210 for topping the base 208. The base 208 and top 210 of each module 102 is fastened together using friction-fit formations, namely in the form of engaging posts 700a, 700b. The posts 700a are axially pushed into hollow posts 700b during assembly to form a snug fit, and can be removed by pulling apart during disassembly.

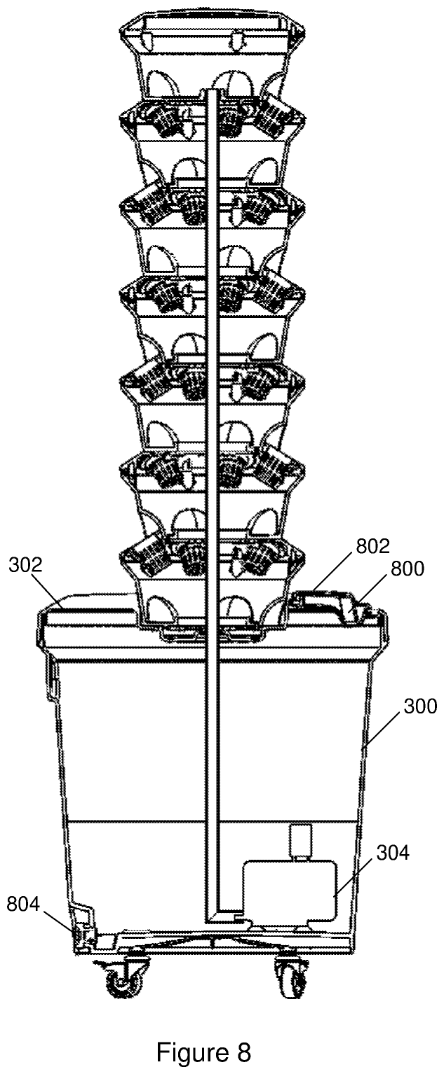

Turing to FIG. 8, the tank 300 includes a lid 302 with an upper water inlet 800. The lid 302 can include a hinged closure 802 for closing the inlet 800. The lid 302 may also be hinged, and the lid 302 and the closure may be latched.

The tank 300 also includes a lower drain 804 for draining water from the tank 300. In particular, the drain 804 includes a drainage hole, and a bung for plugging the hole.

A person skilled in the art will appreciate that many embodiments and variations can be made without departing from the ambit of the present invention.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A modular plant growing system for hydroponic and/or aeroponic growing of plants, the system including:
growing modules for hydroponically and/or aeroponically growing plants, each growing module including a base and a top for topping a periphery of the base, each growing module including twist lock formations to facilitate twist-locking of the modules together,
wherein the twist lock formations include a bayonet fitting.

2. A system as claimed in claim 1, wherein each base and top of the modules can be releasably fastened together.

3. A system as claimed in claim 1, wherein the twist lock formations lock the base and the top of each module together, as well as adjacent modules together.

4. A system as claimed in claim 1, wherein each growing module includes one or more growing ports in which the plants are located.

5. A system as claimed in claim 4, wherein each top and base include one or more aligned recesses for accommodating the plants or friction-fit formations for coupling together.

6. A system as claimed in claim 5, wherein the tops and/or bases be stacked or nested together for transport.

7. A system as claimed in claim 1, wherein the growing modules can fasten together to form a stacked or vertical tower.

8. A system as claimed in claim 7 including more towers, the towers watered from a central water supply which advantageously enables water quality for the towers to be carefully monitored, facilitates cleaning and maintenance, and/or reduces buying costs for the user.

9. A system as claimed in claim 1, wherein including an irrigator for irrigating the plants.

10. A system as claimed in claim 9, wherein the irrigator includes a water tank for receiving water draining from the modules, the tank preferably including a lid which may be latched and/or hinged and include a water inlet; the tank even more preferably including a drain for draining water.

11. A system as claimed in claim 9, wherein the irrigator includes a pump for pumping water to water plants in the modules, the pump preferably being submersible and located within a tank.

12. A system as claimed in claim 9, wherein the irrigator includes a conduit for conveying water from a pump to the topmost growing module.

13. A system as claimed in claim 9, wherein the irrigator includes a spreader for spreading water irrigating the plants.

14. A system as claimed in claim 1, wherein the system includes a drainage conduit for draining water from the modules, forming respective towers, to a central reservoir for irrigation.

15. A system as claimed in claim 1, wherein each part of each module is integrally formed, preferably by injection molding.
